(19) United States
(12) Patent Application Publication
(10) Pub. No.: US 2006/0208915 A1
(43) Pub. Date: Sep. 21, 2006

(54) Liquid level sensor switch

(76) Inventors: Stuart Oakner, Boca Raton, FL (US); Mark T. Brannick, Boca Raton, FL (US); Donna Ellen Oakner Brannick, Boca Raton, FL (US)

Correspondence Address: Robert M. Downey;ROBERT M. DOWNEY, P.A., Suite 300, 601 South Federal Highway, Boca Raton, FL, 33432, US

(21) Appl. No.: 11/370,457

(22) Filed: Mar. 8, 2006

Related U.S. Application Data
(60) Provisional application No. 60/660,053, filed on Mar. 9, 2005.

(51) Int. Cl. G08B 21/00; F25D 21/00

(52) U.S. Cl. 340/620; 62/150

(57) ABSTRACT

A PC board containing electronic components of a normally closed switch is enclosed in a case and connects to a circuit using two wires. Electrically conductive sensor-probe pins extend from the PC board and are positioned for detecting liquids at various levels within drains, drain pans, tanks, reservoirs and pipes of various dimensions. An optional remote probe, having a pair of electrically conductive sensor probe pins, connects to the PC board and is adapted for positioning at a location that is separated from the enclosed case, such as in an auxiliary drain pan of an HVAC system. The normally closed switch is actuated to an open state upon a rising liquid level contacting the tips of the sensor probe pins. Actuation of the switch to the open state changes the status of the circuit from a normally closed circuit condition to an open circuit condition, thereby interrupting operation of a system (e.g. HVAC) on the circuit. Actuation to the open circuit condition may be visibly indicated by an illuminated LED on the exterior of the case. In one embodiment, the circuitry of the liquid level sensor switch is non-polarized, thereby allowing the two wires to be connected to either terminal connection point in the circuit.

This application claims the benefit of U.S. Provisional Patent Application Ser. No. 60/660,053 filed on Mar. 9, 2005.

### BACKGROUND OF THE INVENTION

1. Field of the Invention

This invention relates to liquid level overflow switches and, more particularly, to a normally closed electrical switch having conductor probes positioned relative to a variable level liquid source for opening the switch (switching off a circuit) when the conductor probes come into contact with the liquid source.

2. Discussion of the Related Art

Safety switches which react to changes in liquid level are well known in the art. Most switches of this type use a float member which rises and falls with the changing liquid level in a contained environment (e.g. a drain pipe, drain pan or tank). Float actuated switches are commonly used in equipment and systems to prevent overflow of liquid, such as condensate in air conditioning and refrigeration systems. In particular, float actuated overflow safety switches have been installed in residential and commercial air conditioning and refrigeration systems to prevent condensate from overflowing the drain pan in the event the drain pipe becomes occluded by algae, dirt or other accumulated debris. An occlusion in the outlets or drain pipes of an air conditioning condensate drainage system will eventually result in condensate overflowing the drain pan, causing costly water damage to building ceilings, walls, flooring and other structures and equipment.

Float switches have been found to be effective for deactivating air conditioning and refrigeration systems upon a level of condensate in the condensate drainage system reaching a predetermined level, thereby preventing overflow, and possible damage. However, float actuated overflow safety switches can malfunction if the float element is prevented from moving through its normal range of movement. For instance, the float element may become stuck or jammed, possibly as a result of accumulated algae on the float stem. An adjacent structure that blocks movement of the float element is another possible cause of switch malfunction. In these examples, the float element may not always rise and fall through a full range of motion as the liquid level changes, such as when the condensate level rises in the drain pan or drain line of an HVAC system.

In an attempt to overcome the problems associated with float switches and other related safety switch devices which rely on the use of mechanical moving parts, various electronic probe switch devices have been introduced to the market. These devices eliminate moving parts and, instead, use a pair of probe sensors for detecting rising water levels, such as in the drain pan of an air conditioning or refrigeration unit. However, there are several drawbacks associated with the probe sensor overflow switches presently available on the market. In particular, these devices require use of an independent control module to connect to the electric circuit. Moreover, installation of the presently known probe sensor overflow switch devices requires connection of at least three wires, and in some instances five or more wires, to specific corresponding wires of the same polarity or component in the circuit. These wires are typically color-coded and must be matched with the same corresponding color wires of the system circuit. Unfortunately, the correct connecting wire pairs are not always of the same color. The need for an independent control device and numerous wire connections makes installation of these probe sensing switch devices complicated and costly, and usually requires a skilled technician.

The present invention overcomes the several problems associated with overflow switches in the related art, such as overflow safety switches in air conditioning and refrigeration systems. More specifically, the present invention overcomes the problems set forth above in connection with both float switches and probe sensor overflow switches presently on the market.

The switch device of the present invention uses a pair of conductive probe pins that are electrically connected to a normally closed switch. The switch is connected to a circuit with just two wires and includes an internal sensor for sensing water contact with the probe pins, thereby avoiding the need for a separate control module. When the probe pins make contact with a rising liquid level, the normally closed switch is opened (i.e. switched off) and operation of an electrically operated system (e.g. an air conditioning or refrigeration system) on the circuit is interrupted, thereby preventing further production and accumulation of liquid (e.g. condensate).

### OBJECTS AND ADVANTAGES OF THE INVENTION

With the foregoing shortcomings of the prior art in mind, it is a primary object of the present invention to provide a liquid level sensor switch for opening (i.e. switching off) a circuit upon sensing liquid reaching a predetermined level, and wherein the device is easily connected to the circuit with two wires.

It is a further object of the present invention to provide a liquid level sensor switch that uses electrically conductive probes for sensing liquid in a particular environment reaching a predetermined level, and wherein the switch device and sensor are combined, thereby avoiding the need for a separate or remote control module for connection to an electric circuit.

It is still a further object of the present invention to provide a non-polarized switch device, as set forth above, which uses only two connecting wires that are adapted to be connected to either of the two opposite terminal connections of a circuit.

It is still a further object of the present invention to provide a liquid level sensor switch for use in detecting rising liquid levels in a system, such as an air conditioning or refrigeration system, and wherein the switch device is adapted for connection to a main drain pan, auxiliary drain pan, a drain line, reservoirs, tanks and/or pipes of various dimensions in the system.

It is still a further object of the present invention to provide a liquid level sensor switch device, as set forth above, which is simple to install without requiring any technical expertise.

It is yet a further object of the present invention to provide a liquid level sensor switch, as set forth above, which includes a remote probe sensor and a main probe sensor for detecting undesirable fluid levels at multiple locations, such as the main drain pan, drain line and/or auxiliary drain pan in an HVAC system.

These and other objects and advantages of the present invention are more readily apparent with reference to the following detailed description and accompanying drawings.

### SUMMARY OF THE INVENTION

The present invention is directed to a normally closed switch device that connects to an electrical circuit of a system with two conductor wires and disables the system by opening the circuit upon detecting an undesirable fluid level at one or more locations. The electrical components of the switch are housed on a PC board within a sealed case. Actuation of the switch device to the open circuit condition may be visibly indicated by an illuminated LED on the exterior of the case. In one embodiment, a tubular pipe coupling is integrally formed with the case and includes a first open end, an opposite second open end and an inner wall structure surrounding a fluid receiving chamber between the opposite ends. A central portion of the inner wall structure has a reduced diameter forming shoulders on opposite sides of the central portion for abutting engagement with pipe extensions received through the opposite ends, thereby allowing in-line connection of the pipe coupling to a fluid transfer pipe, such as drain line in an HVAC system. A plug is optionally fitted to the second open end of the pipe coupling when an in-line connection is not needed. Sensor probe pins are connected to extend from the PC board and extend into the chamber of the pipe coupling, with the tips of the probe pins positioned at the predetermined undesirable fluid level. Simultaneous contact of the tips of the sensor probe pins with liquid in the fluid chamber serves to open the normally closed switch, thereby opening the circuit and disabling the system. An optional remote probe, having a pair of spaced sensor probe pins, connects to the PC board via external terminals and can be attached to an auxiliary drain pan, such as in an HVAC system. The circuit is opened when the tips of both of the sensor probe pins on the auxiliary probe are simultaneously immersed in liquid.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of an air handler unit of an air conditioning system showing the switch device of the present invention connected in-line to the main drain line extending from the primary drain pan outlet, with the switch device electrically connected to the air handler unit by use of the two wires;

FIG. 2A is a perspective view of the liquid level sensor switch of the present invention for in-line connection of the device to a drain pipe, as shown in FIGS. 1 and 3A-3B;

FIG. 2B is a perspective view of the liquid level sensor switch device shown with an optional plug for capping off one end of the coupling of the device for installation to a secondary drain pan outlet, as seen in FIG. 7;

FIG. 3A is a cross-sectional view showing the liquid level sensor switch of FIG. 2 connected in-line to sections of a drain pipe and showing the water flowing through the drain pipe at a normal level with the sensor probe pins of the switch device above the water level so that the switch device remains in the normally closed state;

FIG. 3B is a cross-sectional view, similar to FIG. 3A, illustrating the water level in the drain pipe at an abnormally high level, such as in the instance of an occlusion in the drain pipe, with the tips of the sensor probe pins immersed within the water to trigger operation of the switch and open the circuit, thereby interrupting electrical power supply to a system or equipment connected to the circuit;

FIG. 4A is a cross-sectional view showing the liquid level sensor switch connected to a secondary drain pan outlet, as seen in FIG. 7, with one end of the coupling of the device capped off with a removable plug; and showing the sensor probe pins of the switch device above a water level within the fluid receiving chamber of the coupling so that the switch device remains in the normally closed state;

FIG. 4B is a cross-sectional view, similar to FIG. 4A, illustrating the water level in the fluid receiving chamber of the coupling at an abnormally high level, such as in the instance of an occlusion in the drain system, with the tips of the sensor probe pins immersed within the water to trigger operation of the switch and open the circuit, thereby interrupting electrical power supply to a system or equipment connected to the circuit;

FIG. 5A is a schematic diagram of the circuitry of the switch device, in accordance with a first embodiment thereof;

FIG. 5B is a schematic diagram of a portion of the circuitry of the switch of FIG. 5A, in accordance with another embodiment thereof, including an LED indicator that illuminates when the device is actuated to an open circuit condition;

FIG. 5C is a schematic diagram of the circuitry of the switch device, in accordance with a second embodiment thereof;

FIG. 6 is a perspective view showing an air handler unit in an HVAC system with the switch device connected in-line to a drain pipe leading from the primary drain pan and a remote probe fitted to an auxiliary drain pan and electrically connected to the circuitry of the switch device;

FIG. 7 is a perspective view showing an air handler unit in an HVAC system with the switch device capped off at one end and fitted to the primary drain pan outlet and having a remote probe fitted to an auxiliary drain pan and electrically connected to the circuitry of the switch device;

FIG. 8 is perspective view showing the remote probe including a clip for removably attaching the remote probe to the side wall of a drain pan;

FIG. 9A is a side elevational view, in partial cross section, showing the remote probe clipped to the sidewall of the auxiliary drain pan in an HVAC system with the sensor probe pins shown above the normally low condensate liquid level; and

FIG. 9B is a side elevational view, in partial cross section, showing the remote probe clipped to the sidewall of the auxiliary drain pan and illustrating an abnormally high liquid level in the auxiliary drain pan with the sensor probe pins immersed below the liquid level to open the normally closed switch and interrupt operation of the HVAC system.

Like reference numerals refer to like parts throughout the several views of the drawings.

### DETAILED DESCRIPTION OF THE PREFERRED EMBODIMENTS

The liquid level sensor switch is shown throughout the several views of the drawings and is generally indicated as 10. The liquid level sensor switch 10 is a normally closed switch device that connects to the electrical circuit of a system and opens the circuit to disable one or more components in the system, or the entire system, upon detecting an undesirable fluid level at one or more locations.

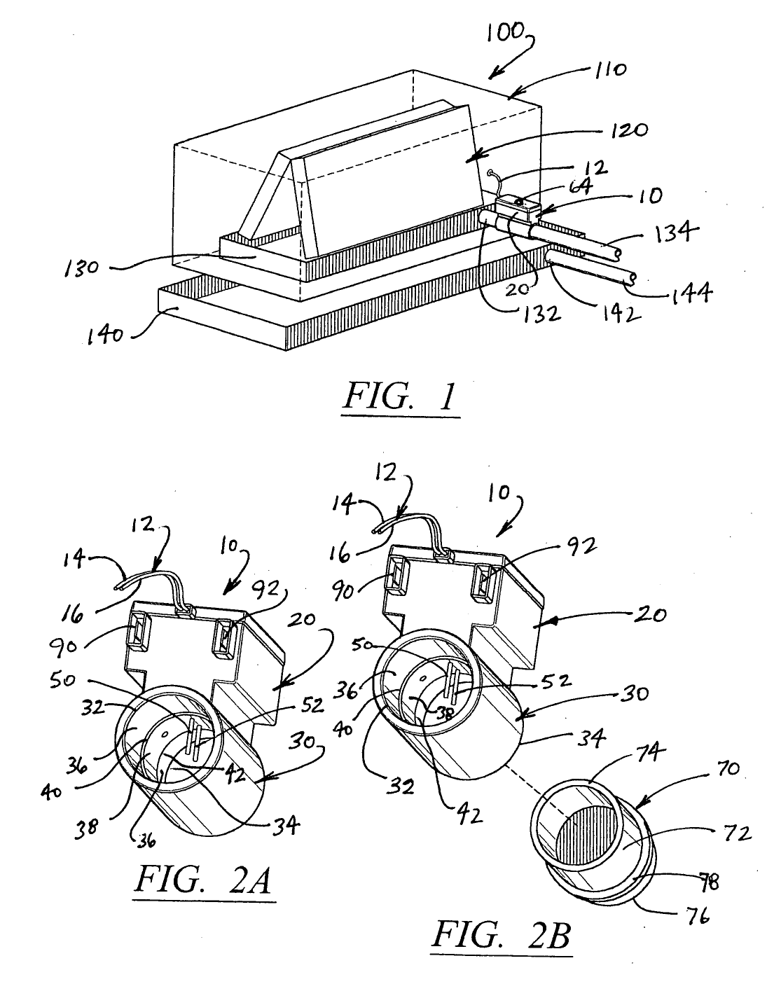

The liquid level sensor switch 10 is particularly suited for use in an HVAC system to shut off the system upon detecting an abnormally high liquid condensate level in the drain pan(s) or drain line(s), thereby preventing further accumulation of liquid condensate and overflow of the drain pan(s). FIG. 1 illustrates a typical example of installation of the switch device 10 in an HVAC system 100. As seen in FIG. 1, the HVAC system 100 includes an air handler unit 110 with a condenser 120 and a primary drain pan 130 directly below the condenser. The primary drain pan 130 includes at least one outlet 132 for connecting a drain line 134. In operation, liquid condensate drips from the coils of the condenser 120 and accumulates within the drain pan 130. The liquid condensate is then directed out through outlet 132 and drain line 134 for release at an appropriate location (e.g. outdoors). The HVAC system 100 may also include an auxiliary drain pan 140 positioned below the air handler unit 110 and the primary drain pan 130. The auxiliary drain pan 140 is typically larger than the primary drain pan 130 so that, in the instance there is an overflow in the primary drain pan 130, the auxiliary drain pan 140 will catch the overflowing liquid condensate. Similar to the primary drain pan 130, the auxiliary drain pan 140 includes at least one outlet 142 which connects with an auxiliary drain line 144.

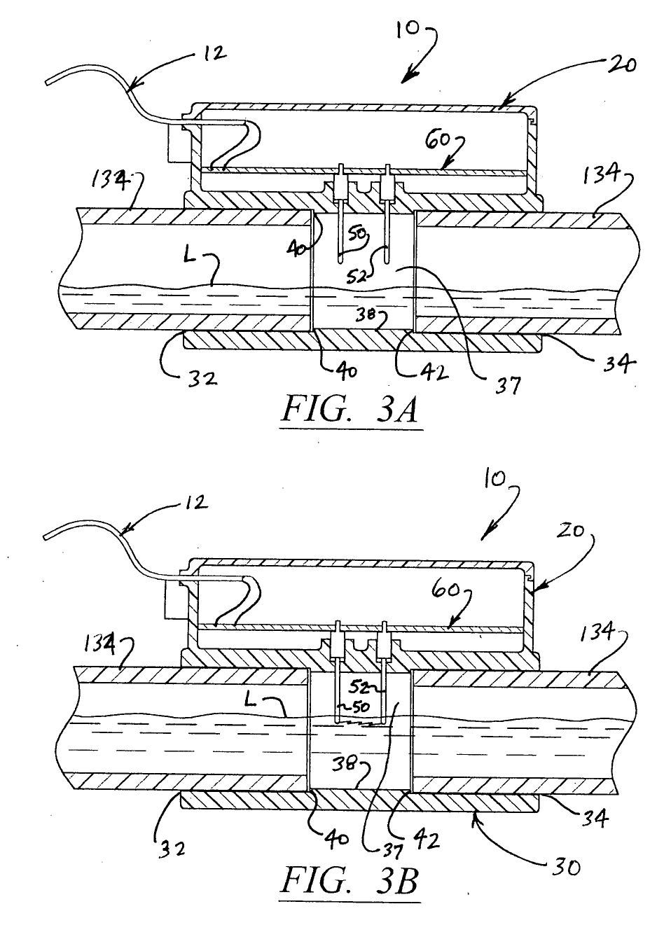

In the example of FIG. 1, the switch device 10 of the present invention is shown connected in-line with the primary drain line 134. A pair of connecting wires 12 are used to electrically connect the circuitry of the switch device 10 to the circuit of the HVAC system 100. For instance, the wires of the wire pair 12 may be connected to the thermostat switch of the HVAC system 100. In the example of FIG. 1, the switch device 10 is adapted to detect an abnormally high liquid level within the drain line 134, as described more fully in reference to FIGS. 3A-3B below.

The liquid level sensor switch device 10 of the present invention includes an electronics housing or case 20. In one preferred embodiment, the case 20 is joined to or integrally molded with a tubular coupling 30. The wire pair 12 extends from the housing 20 and includes a first wire 14 and a second wire 16. The circuitry of the switch device 10 is non-polarized, allowing the two wires 14, 16 to be connected to either terminal connection point in the HVAC system circuit.

In the embodiment shown in FIGS. 1-4B and 6-7, the tubular pipe coupling 30 includes a first open end 32, an opposite second open end 34 and an inner wall surface 36 surrounding a fluid receiving chamber 37 between the opposite ends. The opposite ends 32, 34 and inner wall structure are sized and configured for snug fitted sliding receipt of open end portions of the drain line 134 therein. A central portion 38 of the inner wall structure of the coupling 30 has a reduced diameter forming shoulders 40, 42 on opposite sides of the central portion for abutting engagement with the ends of the drain line extensions 134, as seen in FIGS. 3A-3B. The shoulders 40, 42 limit travel of the ends of the drain line extensions 134 through the interior of the coupling 30 so that the drain line extensions do not strike probe pins 50, 52 extending downwardly within the fluid receiving chamber 37 at the central portion of the coupling. The probe pins 50, 52 are electrically connected to P.C. Board 60 contained within the housing 20. The P.C. Board 60 houses the several electronic components of the switch device 10 and is connected with wire pair 12 for electrical connection with the system circuit (e.g. HVAC system circuit).

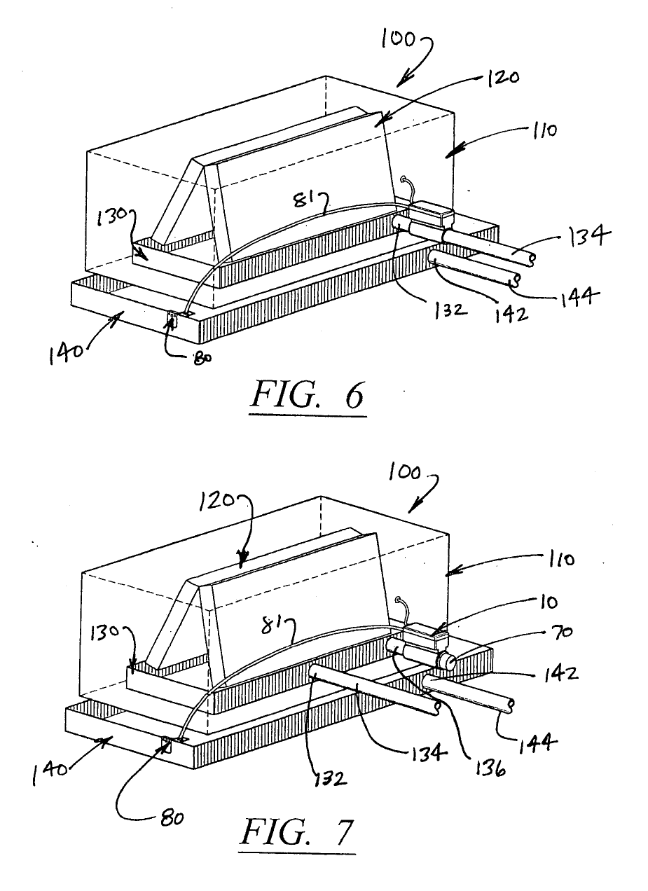

The open end 34 of the coupling 30 may optionally be closed off with the use of a cap member 70. For instance, as seen in FIG. 7, the switch device 10 may be fitted to a secondary drain outlet 136 and capped off at the opposite end 34. The cap member 70 includes a plug portion 72 which is sized and configured for snug fitted sliding receipt within open end 34 for tight fitted engagement with the inner wall surface 36 of the coupling. An annular rim 78 is formed about the cap to serve as a stop member, limiting insertion of the cap member 70 within the open end 34. An outer portion 76 extends beyond the annular rim 78 for grasping with a tool (e.g. pliers, wrench, etc.) to facilitate removal of the cap member 70 from the coupling 30. It is noted that the coupling 30 is shown and described in accordance with one preferred embodiment of the invention, and that other installation methods and structures of the liquid level sensor switch are contemplated within the scope of the invention. For instance, alternative means for mounting the encased P.C. board are contemplated, wherein the sensor probe pins 50, 52 are positioned for detecting liquids at various levels within drains, drain pans, tanks, reservoirs and pipes of various dimension.

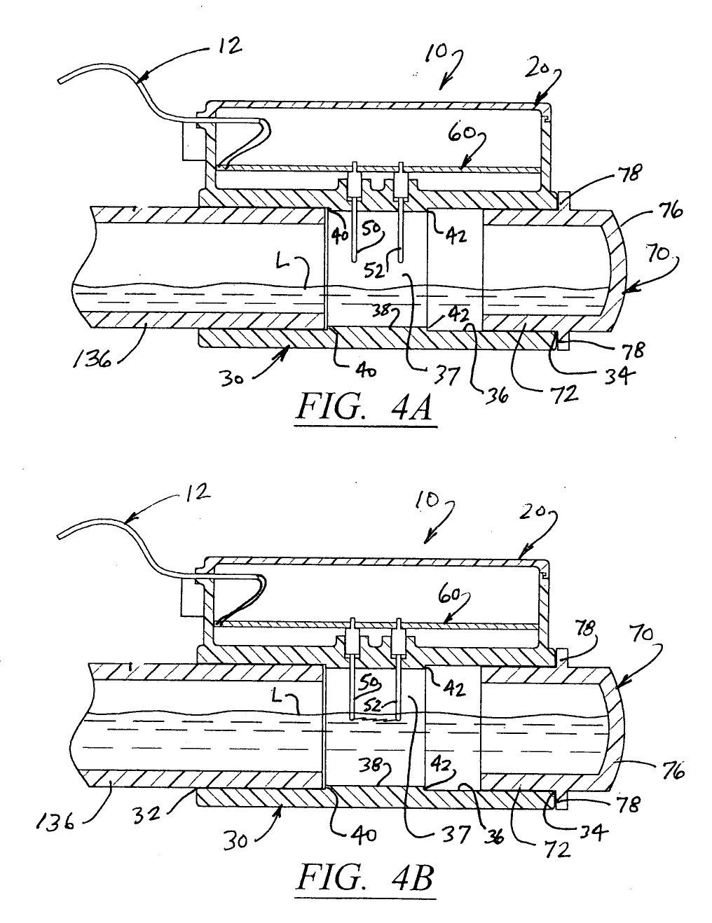

The circuitry on P.C. board 60 provides a normally closed switch that is electrically connected to the circuit (e.g. thermostat switch of the HVAC system), thereby allowing the circuit to normally remain closed as the system components on the circuit operate under normal conditions. FIGS. 3A and 4A illustrate a normal liquid level L within the fluid receiving chamber 37 of the device 10, wherein the tips of the probe pins 50, 52 remain above (i.e. not contacting) the liquid level L. In the event there is a blockage or other abnormality in the drainage system which prevents free flowing drainage of the liquid through the drainage system (e.g. drain lines), the liquid level L will rise within the fluid receiving chamber 37 of the device 10 until, eventually, the tips of the probe pins 50, 52 become submerged below the liquid level L, as seen in FIGS. 3B and 4B. When. this happens, a conductive path is created between the tips of the probe pins 50, 52. The creation of this conductive path between the probe pins 50, 52 causes the normally closed switch to open. Actuation of the switch device 10 to the open state changes the status of the circuit from a normally closed circuit condition to an open circuit condition, thereby interrupting operation of a system (e.g. HVAC system) on the circuit. An LED 64 on the housing 20 illuminates when the switch device 10 is actuated to the open circuit condition. The circuit remains open, with the system inoperable, until the liquid level L lowers below the tips of the probe pins 50, 52.

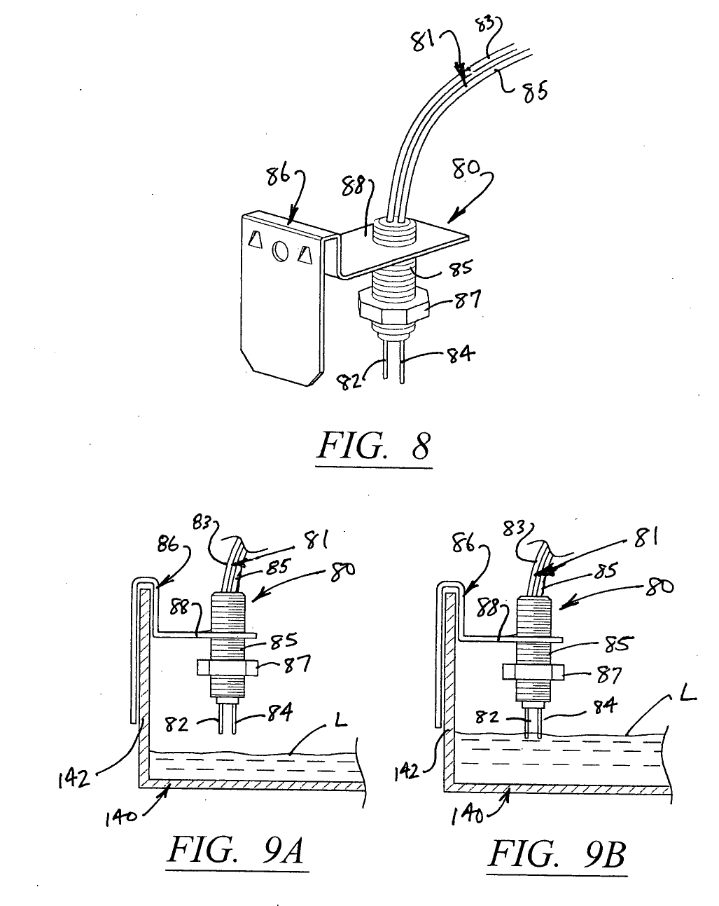

As seen in FIGS. 2A and 2B, the housing 20 is provided with external terminals 90, 92 for connection of a wire pair 81 of a remote probe 80, as seen in FIGS. 6-9B. The remote probe 80 includes probe pins 82, 84 which are electrically connected to corresponding wires 83, 85 of conductor wire pair 81. The non-polarized circuitry of the device 10 allows for connection of the wires 83, 85 to either of the external terminals 90, 92. A clip device 86 allows for removable attachment of the remote probe 80 to the sidewall of a drain pan. In the examples shown in FIGS. 6 and 7, the remote probe 80 is shown attached to the side wall 142 of the auxiliary drain pan 140. The clip device 86 is provided with a horizontal plate 88 which has a hole formed therethrough for threaded passage of a main body of the remote probe 80. This allows for adjusted positioning of the tips of the probe pins 82, 84 within the drain pan when the remote probe 80 is attached to the side wall 142, as seen in FIGS. 9A-9B. More particularly, threaded passage of the exterior threaded surface 85 of the remote probe 80 through the hole in the plate member 88 allows the tips of the probe pins 82, 84 to be selectively raised or lowered relative to the bottom of the drain pan. A nut 87 is provided on the threaded surface 85 of the remote probe body for engagement with the underside surface of the plate member 88 when the probe pins are at the proper adjusted height within the drain pan.

The remote probe 80 operates in the same manner as described in connection with the probe pins 50, 52 described above. Specifically, when the tips of the probe pins 82, 84 of the remote probe 80 are above the liquid level L (see FIG. 9A), the switch device 10 remains in a normally closed state. When the liquid level L in the drain pan 140 rises to an abnormally high level (see FIG. 9B) the tips of the probe pins 82, 84 become submerged below the liquid level L. This creates a conductive path between the probe pins 82, 84 which actuates the switch to an open state. As described above, actuation of the switch to the open state changes the status of the circuit from a normally closed circuit condition to an open circuit condition, thereby interrupting operation of a system (e.g. HVAC system) on the circuit. As seen in FIGS. 6 and 7, installation of the remote probe 80 on the auxiliary drain pan serves as a backup to detect overflow of condensate from the primary drain pan 130 into the auxiliary drain pan 140.

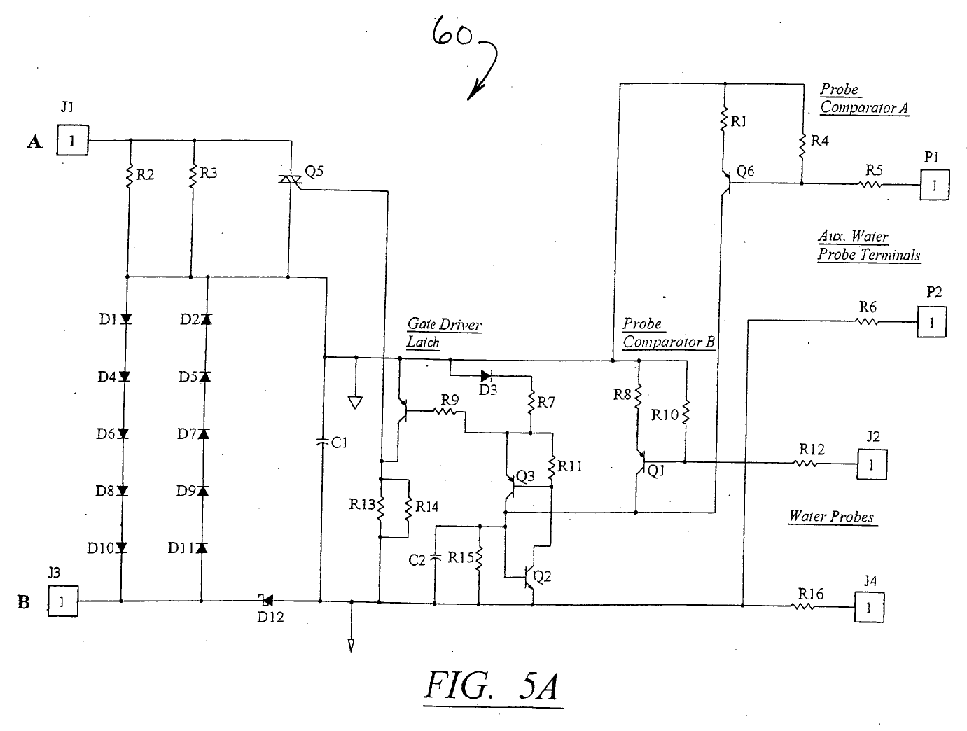

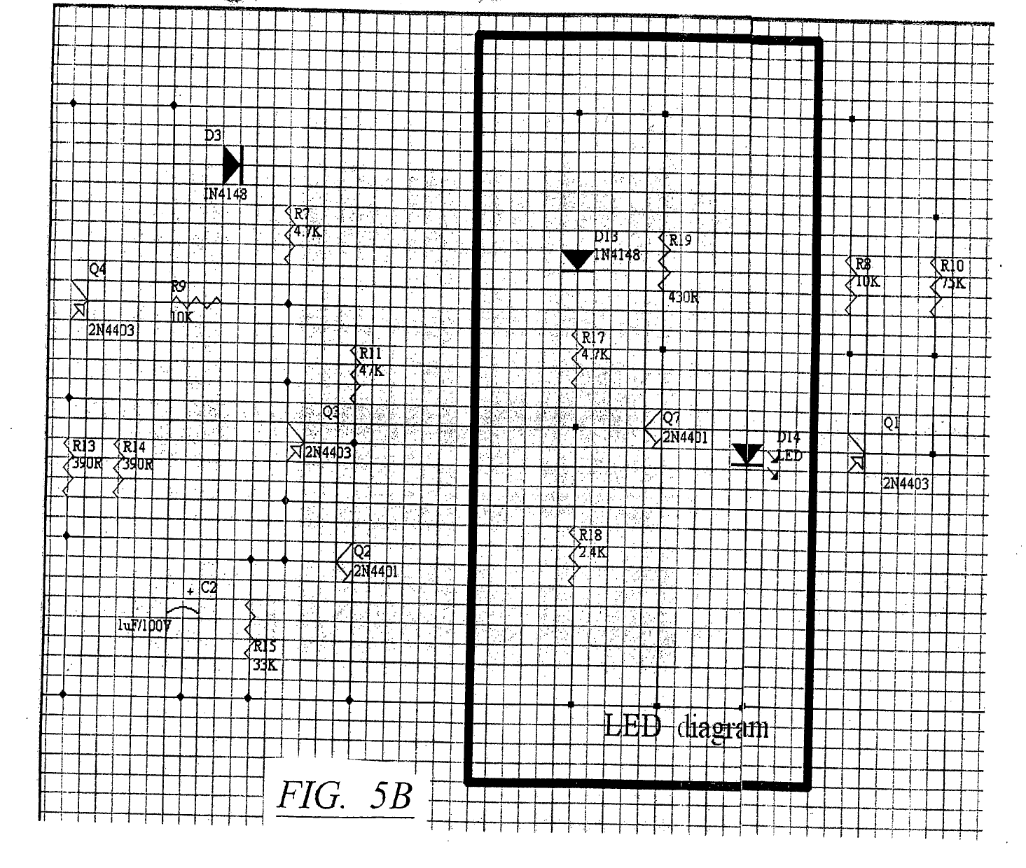

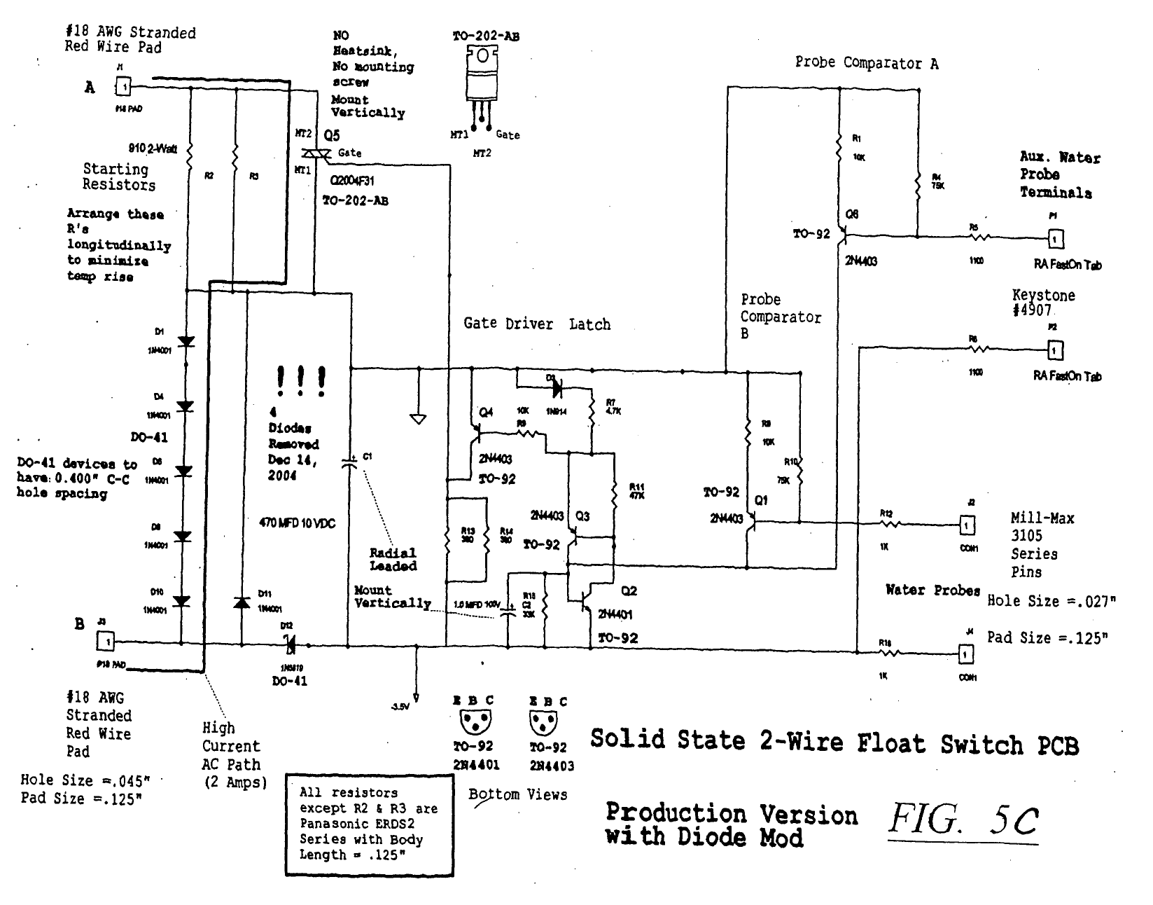

Referring to FIG. 5A, the circuitry of the liquid level sensor switch 10 is shown in accordance with one embodiment. The circuitry uses a parallel network having two legs of series-connected 1N4001 diodes. The two legs are connected in an anti-parallel topology. As seen in FIG. 5, one set of diodes point in one direction and the other set of diodes point in the opposite direction. Current flow through the diodes is in the pointed direction.

The sensor switch circuitry has two sections, namely a voltage derivation and power control section and a water sensor section. The parallel network of diode legs is in the derivation and power control section. The two connecting wires 14, 16 (labeled J1 and J3 in the schematic diagram) extend from the voltage derivation and power control section.

When the switch device 10 is wired in series between a 28 VAC source and a typical HVAC contactor, and the switch device's probe contacts are dry, a “less-than-normal” AC current will flow through the switch device's 910 ohm resistors and one leg of the 1N4001 diodes for a fraction of a second when AC power is first applied (typically by “making” the thermostat). The particular leg of five diodes which first conducts depends on which phase (positive or negative) the AC line happens to be passing through when the thermostat contact is made. “Less-than-normal” current means that the “starting current” being described here is less than the current which the contactor would normally draw if it was connected directly to the 26 VAC source (usually a transformer). This less-than-normal starting current is approximately 20% of the “normal” current. This “normal” current can vary between 50 and 200 milliamperes depending on the particular contactor used in the circuit and the actual voltage of the nominal 26 VAC source, which will vary more-or-less in proportion to the actual AC line voltage (line voltage can vary “normally” from approx. 95 to 130 volts.)

As this starting point, current flows through the switch device's 910 ohm resistors and one of the diode legs, a voltage drop is developed across the five diodes in the leg, as well as across the 910 ohm resistors and the contactor itself. At this point, the Triac is not yet turned on so no current flows through it. The contactor does not have enough current flowing through its coil to allow the contacts to be pulled in, because the 910 ohm resistors limit the current in the 26 VAC-thermostat contactor circuit. Each of the 1N4001 diodes has a voltage drop of approximately 700 millivolts; five of them in series create a voltage drop of about 3.5 volts. It can thus be said that the five 1N4001 diodes “steal” 3.5 volts from the circuit consisting of the transformer, the thermostat, and the contactor. This “stolen” voltage is essentially a separate source of 3.5 VAC. During the first half of the 60-cycle line voltage swing the 3.5 volts appears as positive voltage across one leg of four diodes, while on the second half of the cycle the 3.5 volts appears as a negative voltage across the other leg.

Although both diodes legs are needed so that current can flow through the contactor during both halves of the AC line cycle, thus giving it enough power to maintain a strong pull on the contacts, only the 3.5 VAC which appears in the negative direction is used by the sensor switch to derive enough power to operate the water-probe sensing circuitry and to activate the Triac.

Another diode and a storage capacitor are used to convert the 3.5 VAC stolen voltage during the negative cycle to at least 2.2 VDC that is needed to operate the sense circuitry and activate the Triac. When power is first applied to the sensor switch it takes a few line cycles for the storage capacitor to reach the 2.2 VDC level. But, once it is charged to this voltage, each successive negative half-cycle supplies enough power (via the stolen voltage) to keep it adequately charged.

As the 2.2 VDC climbs to its full value during the first few line cycles after power is applied, this voltage reaches a point where it is large enough to activate the Triac. When the Triac is activated, the 910 ohm resistors are shunted by the Triac, forcing a new circuit topology to form. This “new” circuit consists of the 26 VAC source, the Triac, the two diode legs and the contactor coil. In this configuration, the contactor coil is now experiencing approximately 95% of the “normal” current described above. It is at this point in time that the contactor will actually close, because it is now operating above its designed “pull-in” current. In this new situation the “stolen” voltage actually climbs a little bit because of the increased current through the diode legs. The sensor switch is now in its stable “dry contact” operational state and it can stay in this state as long as the thermostat is made. During one half of the AC line cycle, current flows thru the Triac, one leg of five diodes and the contactor coil, and the 3.5 VDC is being stolen from the circuit. During the other half of the AC line cycle, current flows thru the Triac and the other leg of four diodes, but no voltage is stolen. And the contactor is running effectively at about 95% of its design current.

It should be mentioned that even though these contactors are designated as having “26 VAC” coils, the contacts are pulled in when approximately 15 VAC is applied to the coil. The coil retains its “grip” on the contacts until the coil voltage is dropped to approximately 8 or 9 volts (the so-called “drop-out” voltage).

In our system of 60-Cycle AC power, the line voltage flows in one direction for 8.3 milliseconds and then in the other direction for the next 8.3 milliseconds. There are 60 complete alternations each and every second. Diodes are one-way conductors. By placing them in an AC circuit, the two-phases of the AC current can be directed through different parts of a circuit by virtue of the fact that the AC current is flowing first in one direction and then in the opposite direction. In the sensor switch 10, the AC current will flow first through one leg, than through the opposite leg on each successive half-cycle of the AC line. It doesn't matter which way the two wires 14,16 are hooked up, the AC current must still flow through the both legs in successive half-cycles of the AC line. When that current happens to be flowing in the negative direction, which it must do half of the time, the sensor switch steals the minimum 2.2 VDC it needs to operate.

Now, when the probe contacts are wet, the switch device's sensing circuitry causes the Triac to open (i.e. stop conducting the AC current). The switch device circuitry reverts to the situation it was in when power was first applied. The contactor current now must flow through the 910 ohm resistors, one leg of diodes during one AC half-cycle, and the other diode leg during the successive AC half-cycle. The inclusion of the 910 ohm resistors in the circuit starves the contactor coil of voltage, in fact reducing that voltage to below the contactors designed drop-out voltage. Thus, the contactor opens, even though there is still a fractional current flowing through its coil. This fractional current is enough to power the sensor switch's sensing circuit (via the “stolen” voltage) and hold the Triac off as long as the contacts are wet. Again, the “polarity” of the wires 14, 16 is not important because the AC current must flow in opposite directions during successive AC half-cycles.

In an alternative embodiment, four of the diodes are eliminated in one of the diode legs. These four diodes are eliminated in the positive conducting leg. This is the leg which is not used to steal the 3.5 VAC to power the sensor circuitry of the switch device 10. This was done so that another “voltage stealing” device can be connected in series with the sensor switch and minimize the net voltage stolen from the circuit.

During the AC line half-cycle, when the five diode leg is conducting in the switch device, the single diode leg is conducing in the second device. And during the next successive AC line half-cycle, when the single diode leg is conducting in the switch device, the five diode leg is conducing in the second device. Note that during each half cycle, a total of five diodes are involved in the conduction of current (one in one device, five in the other). Since each diode causes a 700 millivolt drop, the total voltage drop is 4.2 volts. Thus, the contactor's coil is deprived of 4.2 volts from the 26 VAC it would normally have if the sensor switch and the second device were not included in the circuit. Again, the design margin of the contactor accommodates this moderate lack of voltage with little or no loss of performance.

While the invention has been shown and described in accordance with preferred and practical embodiments thereof, it is recognized that departures from the instant disclosure are contemplated within the spirit and scope of the present invention, which is not to be limited except as defined in the following claims as interpreted under the doctrine of equivalents.

What is claimed is:

1. A shut-off device responsive to a change in level of a variable level liquid source within a range of liquid level movement and said device being adapted for connection to an electrical circuit between a power supply source and at least one electrically powered system on the circuit, said device comprising:
a circuitry;
a first conductor connected to said circuitry, and a second conductor connecting to said circuitry, and said first and second conductors being adapted for connection to the electrical circuit;
a sensor probe including a pair of the electrically conductive probe pins connected to said circuitry, including a first probe pin and a second probe pin, and said pair of probe pins being maintained in spaced relation to one another and fixed within the range of movement of the liquid level; and
said circuitry being and disposed to energize the electrically powered system to be enable when at least one of said probe pins is not in contact with the liquid source, and said circuitry being structured and disposed to prevent the electrically powered system from being energized when both of said first and second probe pins are in contact with the liquid source.

2. The device as recited in claim 1 wherein said circuitry is non-polarized.

3. The device as recited in claim 1 wherein said sensor probe is structured and disposed for attachment to a drain pan containing the variable level liquid source.

4. The device as recited in claim 3 wherein said sensor probe includes a clip for removable attachment to a side wall of the drain pan to operatively position said first and second probe pins within a liquid collection chamber containing the variable level liquid source.

5. The device as recited in claim 1 wherein said sensor probe is adapted for attachment to a pipe conduit containing the variable liquid source.

6. The device as recited in claim 3 wherein said sensor probe is remote from said circuitry.

7. The device as recited in claim 5 wherein said sensor probe is remote from said circuitry.

8. The device as recited in claim 1 wherein said circuitry is structured and disposed to function as a normally closed switch when at least one of said first and second probe pins is not in contact with the liquid source.

9. The device as recited in claim 1 further including a plurality of said sensor probes including a primary sensor probe and at least one remote sensor probe.

10. A device for connection to an electrical circuit between a power supply source and at least one electrically powered system on the circuit, said device comprising:
a circuitry for regulating and controlling flow of electric current therethrough;
a first conductor extending from said circuitry, and a second conductor extending from said circuitry, said first and second conductors being adapted for connection to the electrical circuit in an arrangement that causes flow of electric current between the power supply source and the at least one electrically powered system to be directed through said circuitry of the device;
a pair of electrically conductive probe pins connected to said circuitry, including a first probe pin and a second probe pin, and said pair of probe pins being maintained in spaced relation to one another, and said pair of probe pins being positionable to contact a variable level liquid source upon the liquid source reaching a predetermined level; and
said circuitry being structured and disposed to permit current flow through said circuitry in a manner that allows the electrically powered system to be energized when at least one of said probe pins is not in contact with the liquid source, and said circuitry being furthered structured and disposed to prevent the electrically powered system from being energized when both of said first and second probe pins are in contact with the liquid source.

11. The device as recited in claim 10 wherein said circuitry in non-polarized.

12. The device as recited in claim 11 wherein said pair of electrically conducted probe pins are part of a sensor probe.

13. The device as recited in claim 12 wherein said sensor probe is structured and disposed for attachment to a drain pan that collects the liquid source.

14. The device as recited in claim 13 wherein said sensor probe includes a clip for removable attachment to a side wall of the drain pan to operatively position said first and second probe pins within a liquid collection chamber of said drain pan.

15. The device as recited in claim 11 wherein said first and second probe pins are adapted to be operatively positioned within a pipe conduit containing the variable level liquid source.

16. The device as recited in claim 12 wherein said sensor probe is remote from said circuitry.

17. A device for interrupting electric power supply to an electrically powered component on a circuit upon detecting a level of liquid in a liquid collection chamber reaching a predetermined level, said device comprising:
a non-polarized circuitry;
a first conductor connected to said circuitry, and a second conductor connected to said circuitry, said first and second conductors being adapted for connection to the circuit;
a pair of electrically conductive probe pins connected to said circuitry, including a first probe pin and a second probe pin, and said pair of probe pins each having a distal tip, and said pair of probe pins being adapted to be positioned so that said distal tips of said first and second probe pins are at said predetermined level; and
said circuitry having a normally closed switch structured and disposed to permit current flow through said circuitry in order to energize the electrically powered system when at least one of said probe pins is not in contact with the liquid in the liquid collection chamber, and said normally closed switch being further structured and disposed to operate to an open condition to prevent the electrically powered system from being energized when both of said first and second probe pins are in contact with the liquid upon the liquid reaching the predetermined level.

18. The device as recited in claim 17 wherein said first and second probe pins are part of a sensor probe.

19. The device as recited in claim 18 wherein said sensor probe is structured and disposed for attachment to a drain pan that collects the liquid source.

20. The device as recited in claim 17 wherein said first and second probe pins are adapted to be operatively positioned within a pipe conduit containing the variable level liquid source.
